(19) United States
(12) Patent Application Publication
(10) Pub. No.: US 2006/0000069 A1
(43) Pub. Date: Jan. 5, 2006

(54) Molded hooks with a safety bail

(76) Inventor: Bernard Mair, Thornhill (CA)

Correspondence Address: KENNETH M. GARRETT, 392 LAKESHORE ROAD EAST, OAKVILLE, ON, L6J 1J8, CA

(21) Appl. No.: 10/880,562

(22) Filed: Jul. 1, 2004

(51) Int. Cl. F16B 45/00

(52) U.S. Cl. 24/598.7; 24/599.1

(57) ABSTRACT

In a molded hook of the type commonly used for securing an elastic cord or the like having a safety bail which captures the hook onto an object to which it is attached, the bail is latchably closable, so as to form with the hook finger a closed loop which is desirably in tension, to increase the structural integrity of the bail and of the hook finger. The bail is suitably mounted for rotational movement, and the hook may be molded from high strength polymers, to reduce the size of the molded hooks for a given duty performance and/or to increase the duty performance of a hook for a given size.

### FIELD OF INVENTION

This invention relates to hooks for the securement of a flexible member such as a cord to an object, for example when lashing down a load onto a carrying rack. It is particularly described it in relation to hooks for the securement of elastically extensible cords, but it is not restricted thereto.

### BACKGROUND OF THE INVENTION

Hooks for securing cords, particularly elastic cords, are well known in commerce and described in the patent arts. In general, the hooks as a whole comprise a finger having at its proximal end a base, which is a structured to facilitate the attachment of a cord to the hook. The finger has a distal end and a crook portion between the ends, whereby the distal end is adjacent to but spaced apart from the proximal end to form therewith a recess extending towards the crooked portion, and a mouth opening to the recess. Exemplary of the patent art are the following documents:
U.S. Design Pat. 307,705, of common inventorship herewith;
U.S. Pat. No. 6,401,309 (Yang);
U.S. Pat. 6,308,383 (Schrader).
   Much of the prior art is directed to improvements in the means for attaching the cord to the base of the hook, particularly where this is directed to means for easily adjusting the effective the length of the cord. Where it is not desired to easily adjust the effective length of the cord, the base may be more simply structured to permit attachment of the cord by knotting, stapling or clamping, for example. Little attention appears to have been directed to improvements in the safety performance or the strength/size of the hook

In my U.S. design patent aforesaid, and also in the—309 patent, there are illustrated hooks having a deflectable bail which is rooted to the base portion of the hook, and which extends across the mouth of the hook to adjacent the distal end of the finger. While the function of this bail is not defined in the above documents, its intended purpose will be readily apparent to persons both skilled and unskilled in the art. In effect, the bail will deflect inwardly into the recess of the hook as the hook is engaged about an object, and will then revert to its non-deflected position to trap the object, which may be disengaged from the hook only when the bail is manually deflected. In practice, the safety bail is relatively slender and fragile, and is relatively easily stressed beyond its elastic limit, whereby it might become non-operational, and possibly permit the hook to disengage from the object. One reason for the poor mechanical performance of a safety bail of the above type is that a hook with a deflectable bail will normally be molded from olefin polymer type thermoplastic, and these have relatively poor tensile properties, A further disadvantage of hooks molded from this class of polymers is that the hooks are relatively large, particularly when compared to common types of wire hooks rated for a comparable duty.

It will be understood that the hooks to which the invention relates are relatively low-cost items, and any solution to the above problems of performance and safety should not engender a significant increase in cost.

It is an object of this invention to provide hooks of increased safety, which are better able to resist detaching forces to which they may become exposed during use.

It is another object of this invention to provide safety hooks which may be molded from a wider range of polymeric materials than has heretofore been possible, so as to permit the manufacture of hooks with increased duty characteristics and/or reduced size.

It is still another object of this invention to provide improved hooks with little or no commensurate increase in manufacturing costs.

### SUMMARY OF THE INVENTION

In accordance with a broad aspect of this invention, a safety hook comprises a finger having a proximal end with a base portion structured to facilitate the connection of a flexible member such as an elastic cord to the hook, the finger further having a distal end and a crook between the ends, so that the distal end is proximate the proximal end but spaced apart therefrom to define a mouth opening to a recess extending towards the crook, and a safety bail mounted from the finger so as to be movable between a first, closed position extending across the mouth whereby it will trap an object disposed within the recess, and a second, open position permitting the entry of an object through the mouth into the recess or its removal therefrom, as desired. Co-operative latching elements are disposed on the bail and on the finger that are engageable as the bail moves from its second position to its first position, serving to latch the bail closed. In its latched closed position, the bail will be anchored at the opposed ends thereof, to form with finger portions a closed loop structure, serving to transmit to the proximate end of the finger tensile forces to which the distal end of the finger may be subject; and permitting the bail to resist greater torsional forces than would be the case where it is anchored at one end only.

Suitably, the bail circumscribes at least a portion of the distal end of the finger when latched in its first position, and preferably, also at least a portion at least a proximal end of the finger. Most suitably and preferably, the bail will circumscribe the distal end and the proximal end of the finger completely, to maximize the strength of the hook and its capability to resist torsional forces.

While the bail may be integrally rooted to the finger so as to be moveable between its first and second positions by resilient deflection, it is advantageous from the viewpoint of maximizing the performance characteristics of the hook to form the bail and the finger separately, so as to permit a wider choice of materials of construction. Desirably the bail is captured on the finger so as to not to become lost or mislaid. In accordance with the preferred embodiment, the bail comprises a relatively rigid rectangular frame including lateral members united by transverse members. The finger is provided with a grooved opening within which one of the transverse members is snap engageable for rotational movement of the bail. The other of the transverse members forms a part of the co-operative latching elements, and a mating latching element comprising a ramp surface is formed on the finger. Suitably, the grooved recess and ramp surface are formed on the outermost peripheral surface portion of the finger, whereby the bail will circumscribes opposed portions of the finger when in its closed position.

The foregoing objects, aims and advantages of the invention, together with still further objects, aims and advantages, will become more apparent from a consideration of the ensuing description of a presently preferred embodiment, in conjunction with the drawings annexed hereto.

### BRIEF DESCRIPTION OF THE DRAWINGS

In the drawings:

FIG. 1 shows a hook in accordance with the invention in a perspective view, with the bail of the hook removed to show greater detail;

FIG. 2 shows the bail of the hook in perspective view;

FIG. 3 shows the hook in side elevation with the bail in its closed position, and in dashed outline in its open position, and

FIG. 4 shows the hook in plan view from above.

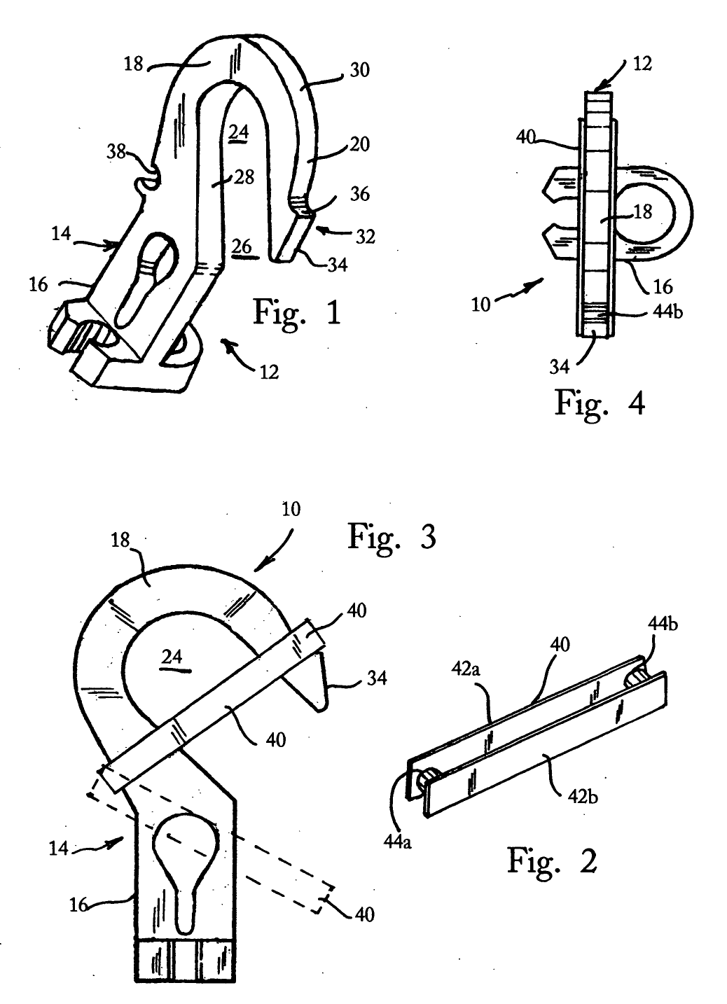

### DESCRIPTION OF THE PREFERRED EMBODIMENT

Referring to the drawings in detail, a safety hook in accordance with the invention is identified therein by the numeral 10. Hook 10 comprises a finger 12 having a proximal end 14 which includes a base portion 16 structured to permit the securement to the hook of an elastic cord (not shown). The base portion 16 shown is illustrative of structure which permits the adjustable type of securement, and other structures to permit either an adjustable or a non-adjustable securement may be used as desired. Finger 12 has a crooked portion 18 and a distal end 20, which together with the proximal portion 14 define a hook recess 24 and a mouth opening 26 thereto. Finger 12 has an inner peripheral wall surface 28 and an outer peripheral wall surface 30. The distal end 20 of finger 12 is provided on the outer peripheral wall surface 30 thereof with a barb 32 comprising an outwardly upwardly directed ramp surface 34 terminated by a downwardly stepped shoulder 36. Finger 12 at the proximal end 14 thereof is provided with a grooved opening 38 that is suitably approximately in diametric opposition to shoulder 36.

Hook 10 further includes a bail 40 which is generally in the form of a relatively rigidrectangular frame comprising a pair of longitudinally extending side members 42a, 42b connected by a pair of circular transverse members 44a, 44b, which are spaced apart therebetween by a dimension marginally less than that between grooved opening 38 and shoulder 36. In practice, bail 40 may conveniently be formed so as to be symmetrical, and the pair of side members, and the pair of end members are here differentiated solely to facilitate the ensuing description. Bail 40 is assembled onto finger 12 by passing the distal end 20 thereof through the bail, and snap fitting transverse end 44a into grooved opening 38, whereby the bail is rotatably captured on finger 12. Assuming bail 40 to be mounted on finger 12 in the foregoing manner, and assuming further that the bail is in its open position as shown in dashed outline in FIG. 3, hook 10 may be hooked onto a suitable object, following which the bail is rotated towards its closed position. Initially, transverse member 44b will ride up on ramp surface 34, and deflect the distal end 20 of finger 12 towards the proximal end 14 thereof, and ultimately snap behind shoulder 36 to latch the bail closed, and thereby trap the object engaged by the hook. In this closed position, bail 40 will circumscribe opposed, spaced apart portions of finger 12 to form therewith closed, tensioned loop structure that is significantly stronger in all parts than comparable safety hooks of the prior art wherein the safety bail is anchored at one end only, which do not provide a physical link across the mouth of the hook.

As indicated earlier, where the safety bail is mounted in a manner so as to necessitate a significant degree of elastic deflection when the hook is engaged with or disengaged from an object, this imposes a restriction upon the nature of the polymers from which such hooks may be molded. In this preferred embodiment, there is no comparable restriction, and finger 12 may be molded from polymers having superior properties such as polycarbonates. This permits the size of the hook to be reduced for a given duty, in comparison to hooks molded from olefin polymers, for example, whereby the overall increase in manufacturing costs will have a relatively insignificant effect on the market price of the hooks.

Bail 40 is easily released from its latched condition by applying finger pressure to distal end 20 tending to close crook portion 18, thereby permitting transverse member 44b to ride up on shoulder 36 as the bail is swung towards its open position.

It will be appreciated that many changes may be made to the hook 10 of the preferred embodiment within the spirit of the invention, and it is intended that these be included in the claims annexed hereto.

1. A molded safety hook for securing a flexible element to an object, said hook comprising a unitary finger having a proximal end with a base portion structured to permit the attachment of said flexible member to said hook, and a distal end with a crook there between whereby said distal end is proximate said proximal end but spaced apart there from to define a hook recess extending towards said crook and a mouth opening thereto;
a safety bail movable between a first, closed position in which it will trap said object when disposed within said recess and a second, open position to permit the passage of said object through said mouth into and from said recess as desired;
cooperative latching elements disposed on said finger and said bail engageable as said bail moves into said first position from said second position serving to latch said bail in said closed position so as to form with finger portions a closed loop.

2. A molded safety hook as defined in claim 1 wherein said bail circumscribes at least a portion of said distal end of said finger when latched in its closed position.

3. A molded safety hook as defined in claim 1 wherein said bail circumscribes at least a portion of said proximal end of said finger when in its latched position.

4. A molded safety hook as defined in claim 1 wherein said bail circumscribes at least a portion of said distal end and said proximal end of said finger when in its latched position.

5. A molded safety hook as defined in claim 4 wherein said cooperative latching elements include a ramp surface disposed on said finger, and wherein movement of said bail towards its latched position urges said distal end of said finger towards said proximal end thereof.

6. A molded safety hook as defined in claim 5 wherein said ramp surface is disposed on said distal end of said finger.

7. A molded safety hook as defined in claim 5 wherein said bail is relatively rigid, and wherein said proximal end of said finger is provided with a bearing opening within which said bail is mounted for rotational movement between said open and closed positions.

8. A molded safety hook as defined in claim 7 wherein said ramp surface and said bearing opening are formed on outer peripheral surface portions of said finger.

9. A molded safety hook as defined in claim 1 wherein said bail when in its closed position acts to generate a tension in said loop.

10. A molded hook including a safety bail for retaining the hook in hooked connection with an object, with actuation of the bail permitting the release of such connection, said hook comprising a unitary, resilient finger with opposed ends and a crooked intermediate portion, wherein said bail is relatively rigid and is hingedly connected to said finger adjacent one said end to be rotatable between a first, closed position wherein said bail is latched to said finger adjacent the other said end to form with said finger including said crooked portion a closed loop acting to trap an object engaged in hook connection by said hook, and a second, open position to permit the release of said hook from said hooked connection.

11. A hook as defined in claim 10 wherein said bail when in its first position acts to tension said loop.

12. A hook as defined in claim 10 wherein said bail circumscribes said finger when in its closed position.

13. A hook as defined in claim 7 molded from polycarbonate resin.

14. A hook as defined in claim 10 molded from polycarbonate resin.

15. A hook as defined in claim 11 molded from polycarbonate resin.
